(19) United States
(12) Patent Application Publication
(10) Pub. No.: US 2024/0094693 A1
(43) Pub. Date: Mar. 21, 2024

(54) PREDICTION METHOD OF WIND POWER OUTPUT, ELECTRONIC DEVICE, STORAGE MEDIUM, AND SYSTEM

(71) Applicant: BOE Technology Group Co., Ltd., Beijing (CN)

(72) Inventors: Zhuoshi Yang, Beijing (CN); Xibo Zhou, Beijing (CN)

(73) Assignee: BOE Technology Group Co., Ltd., Beijing (CN)

(21) Appl. No.: 18/271,966

(22) PCT Filed: Sep. 21, 2022
(86) PCT No.: PCT/CN2022/120325

§ 371 Date: Jul. 12, 2023

(30) Foreign Application Priority Data
Dec. 31, 2021 (CN) 202111679744.7

(51) Int. Cl. G05B 19/042

(52) U.S. Cl. CPC G05B 19/042; G05B 2219/2619

(57) ABSTRACT

The present disclosure provides a prediction method of wind power output, an electronic device, a storage medium and a system, and relates to the technical field of wind power. The method includes: periodically acquiring an initial meteorological data set corresponding to each received time node, wherein the initial meteorological data set includes initial meteorological sub-data of at least one dimension of at least one meteorological element; after acquiring the latest initial meteorological data set, identifying and smoothing the abnormal sub-data to obtain a smoothed meteorological data set; determining an average wind energy density in a target time period; taking the smooth meteorological data set and the average wind energy density in the target time period as the input features of the model, and obtaining a wind power output predictive value via the model.

The present disclosure claims priority to Chinese Patent Application No. 202111679744.7, entitled “Wind Power Output Prediction Method, Electronic Device, Storage Medium. and System”, filed on Dec. 31, 2021 by China Patent Office, which is incorporated herein by reference in its entirety.

### TECHNICAL FIELD

The present disclosure relates to the technical field of wind power, in particular to a prediction method of wind power output, an electronic device, a storage medium and a system.

### BACKGROUND

With the development of wind power generation technology, the capacity of a single fan and the scale of a wind power station continue to expand, the proportion of wind power in the total generation of power system is increasing year by year. With the increasing penetration power of the wind power stations, a series of problems brought to the power system are becoming increasingly prominent, which is not conducive to the safe, stable, economic, and reliable operation of power systems. The timely and accurate prediction of wind power output can enhance the safety, stability, economy, and controllability of the power system.

### SUMMARY

The present disclosure provides a prediction method of wind power output including:
periodically acquiring an initial meteorological data set corresponding to each received time node; wherein each of the initial meteorological data sets comprises initial meteorological data corresponding to at least one meteorological element on a one-to-one basis, and the initial meteorological data comprises initial meteorological sub-data of at least one dimension of the meteorological element corresponding thereto;
identifying abnormal sub-data from each latest initial meteorological sub-data after acquiring the latest initial meteorological data set corresponding to the latest received time node;
smoothing the identified abnormal sub-data to obtain a smoothed meteorological data set when the abnormal sub-data is identified, and taking the latest initial meteorological data set as a smoothed meteorological data set when the abnormal sub-data is not identified;
determining an instantaneous wind energy density corresponding to the latest received time node;
performing rolling averaging calculation on the instantaneous wind energy density to obtain an average wind energy density within a target time period wherein the target time period includes the latest received time node; and
inputting the smoothed meteorological data set and the average wind energy density in the target time period as input features into a wind power output predictive model, so that the wind power output predictive model outputs a wind power output predictive value of the target time period.

Optionally, the performing rolling averaging calculation on the instantaneous wind energy density to obtain an average wind energy density within a target time period includes:
rolling the first-tune window along the time axis to align the first-time window with the target time period; and
averaging a plurality of instantaneous wind energy densities in a first-time window to obtain an average wind energy density in the target time period.

Optionally, the smoothed meteorological sub-data in the smoothed meteorological data set comprises at least a smoothed wind speed and a smoothed air density at a hub of the fan, and the determining the instantaneous wind energy density corresponding to the latest received time node comprises:
determining the instantaneous wind energy density corresponding to the latest received time node according to the smooth wind speed and the smooth air density at the hub of the fan corresponding to the latest received time node.

Optionally, the identifying abnormal sub-data from each latest initial meteorological sub-data after acquiring the latest initial meteorological data set corresponding to the latest received time node comprises:
rolling a second time window along a time axis so that the second time window comprises the latest received time node after acquiring the latest initial meteorological data set corresponding to the latest received time node;
performing normal normalization processing on the initial meteorological sub-data which belongs to the same dimension of the same meteorological element and is a non-null value in the second time window to obtain a normal normalization value corresponding to each latest initial meteorological sub-data; and
determining the latest initial meteorological sub-data for which the normal normalized value is not within the preset value range to be the abnormal sub-data.

Optionally, after the rolling a second time window along a time axis so that the second time window comprises the latest received time node after acquiring the latest initial meteorological data set corresponding to the latest received time node, the method further comprises:
determining a null value in each of the latest initial meteorological sub-data within the second time window as the abnormal sub-data.

Optionally, the smoothing each of the identified abnormal sub-data to obtain a smoothed meteorological data set when the abnormal sub-data is identified comprises:
rolling a third time window along a time axis for any one of the identified abnormal sub-data, so that the third time window comprises the received time node corresponding to the abnormal sub-data and a plurality of received time nodes preceding the received time node corresponding to the abnormal sub-data;
averaging on initial meteorological sub-data which belongs to the same dimension of the same meteorological element as the abnormal sub-data in the third time window to obtain a new value corresponding to the abnormal sub-data; and
replacing each abnormal sub-data with a corresponding new value to obtain a smoothed meteorological data set.

Optionally, the periodically acquiring an initial meteorological data set corresponding to each received time node comprises:
periodically acquiring an initial meteorological data predictive set corresponding to each received time node; wherein the initial meteorological data predictive set is predicted based on a historical initial meteorological data truth value set corresponding to at least one historical received time node.

Optionally, the periodically acquiring an initial meteorological data set corresponding to each received time node comprises:
periodically acquiring an initial meteorological data truth value set corresponding to each received time node.

Optionally, before the periodically acquiring an initial meteorological data set corresponding to each received time node, the method further comprises:
acquiring a plurality of first sample sets; wherein the first sample set includes a smooth meteorological data set sample corresponding to each historical received time node in a historical time period, an average wind energy density sample in the historical time period, and a wind power output truth value sample in the historical time period;
constructing a boosting model;
training the boosting model according to the plurality of first sample sets to obtain a trained boosting model; and
generating the wind power output predictive model according to the trained boosting model.

Optionally, the training the boosting model according to the plurality of first sample sets to obtain a trained boosting model comprises:
training the boosting model by a cross-validation method according to the plurality of first sample sets to obtain a trained boosting model.

Optionally, before inputting the smoothed meteorological data set and the average wind energy density within the target time period as input features into a wind power output predictive model, so that the wind power output predictive model outputs a wind power output predictive value of the target time period, the method further comprises:
acquiring a historical wind power output truth value corresponding to each received time node in the target time period;
wherein the inputting the smoothed meteorological data set and the average wind energy density within the target time period as input features into a wind power output predictive model, so that the wind power output predictive model outputs a wind power output predictive value of the target time period, includes:
inputting the historical wind power output truth value, the smoothed meteorological data set, and the average wind energy density within the target time period as input features into a wind power output predictive model, so that the wind power output predictive model outputs a wind power output predictive value of the target time period.

Optionally, before generating the wind power output predictive model according to the trained boosting model, the method further comprises:
acquiring a plurality of second sample sets; wherein the second sample set comprises a historical wind power output truth value sample corresponding to each historical received time node in the historical time period;
constructing a time series model;
training the time series model according to the plurality of second sample sets to obtain a trained time series model; and
the generating the wind power output predictive model according to the trained boosting model comprises:
stacking and fusing the trained boosting model and the trained time series model, to obtain the wind power output predictive model.

Optionally, the method further comprises:
re-training the wind power output predictive model according to a plurality of new first sample sets and a plurality of new second sample sets to update the wind power output predictive model after the plurality of new first sample sets and the plurality of new second sample sets are acquired.

Optionally, the meteorological elements include wind speed, gas density, gas pressure and air temperature.

Optionally, the latest initial meteorological sub-data comprises at least the latest initial wind speed at the hub of the fan, the method further includes:
monitoring the initial wind speed at the hub of the fan acquired each time starting from the latest received time node after acquiring the latest initial meteorological data set corresponding to the latest received time node when the latest initial wind speed at the hub of the fan is less than a first preset wind speed or greater than a second preset wind speed; wherein the first preset wind speed is less than the second preset wind speed; and
performing warning according to the each acquired initial wind speed at the hub of the fan monitored in a preset period of time.

Optionally, the performing warning according to the each acquired initial wind speed at the hub of the fan monitored in a preset period of time comprises:
outputting a warning for recommending to turn off the fan of a wind power station when each acquired initial wind speed at the hub of the fan monitored within the preset period of time is less than the first preset wind speed; or
counting a quantity of wind speed data less than the first preset wind speed in each acquired initial wind speed at the hub of the fan monitored in the preset period of time; and
outputting a warning for recommending to turn off the fan of the wind power station when the quantity of the wind speed data is greater than a first preset quantity.

Optionally, the performing warning according to the each acquired initial wind speed at the hub of the fan monitored in a preset period of time comprises:
outputting a warning for recommending to turn off the fan of the wind power station when each acquired initial wind speed at the hub of the fan monitored within a preset period of time is greater than a second preset wind speed; or
counting a quantity of wind speed data greater than the second preset wind speed in each acquired initial wind speed at the hub of the fan monitored in the preset period of time; and
outputting a warning for recommending to turn off the fan of the wind power station when the quantity of the wind speed data is greater than a second preset quantity.

The disclosure further discloses an electronic device, including a processor, a memory and a program stored on the memory and executable on the processor, which when executed by the processor, implementing the steps of the prediction method of wind power output described above.

The disclosure further discloses a non-transitory computer-readable storage medium, wherein instructions in the storage medium, when executed by a processor of an electronic device, enable the electronic device to perform the prediction method of wind power output above.

The disclosure further discloses a wind power control system, comprising a plurality of data acquisition devices, a control device, and the electronic device above, wherein the data acquisition devices are provided in a wind power station, the data acquisition devices are communicatively connected to the control device, and the control device is communicatively connected to the electronic device;
wherein the data acquisition device is configured to acquire original meteorological sub-data in the wind power station and to transmit the original meteorological sub-data to the control device; and
the control device is configured to generate an initial meteorological data set according to each of the original meteorological sub-data, and transmit the initial meteorological data set to the electronic device according to a preset time interval, so that the electronic device performs wind power output prediction; and each of the initial meteorological data sets corresponds to a received time node received by the electronic device.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the related art, the figures that are required to describe the embodiments or the related art will be briefly described below. Apparently, the figures that are described below are embodiments of the present disclosure, and a person skilled in the art can obtain other figures according to these figures without paying creative work.

FIG. 1 illustrates a flow chart of the steps of a prediction method of wind power output according to an embodiment of the present disclosure;

FIG. 2 illustrates a flow chart of steps of another prediction method of wind power output according to an embodiment of the present disclosure;

FIG. 3 illustrates a flow chart of steps of training a wind power output predictive model according to an embodiment of the present disclosure;

FIG. 4 illustrates another flow chart of steps of training a wind power output predictive model according to an embodiment of the present disclosure;

FIG. 5 illustrates a flow chart of steps of a wind power station warning according to an embodiment of the present disclosure;

FIG. 6 illustrates a block diagram of a wind power control system according to an embodiment of the present disclosure.

### DETAILED DESCRIPTION OF THE EMBODIMENTS

In order to make the objects, the technical solutions and the advantages of the embodiments of the present disclosure clearer, the technical solutions of the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

Unless otherwise defined, the technical or scientific terms used in the present disclosure shall have the usual meaning understood by persons with general skill in the field to whom the present disclosure belongs. The terms “first”, “second” and similar terms used in the present disclosure do not indicate any order, number or importance, but are only used to distinguish different components. Similarly, words such as “a/an”, “one” or “the” do not imply a quantitative limit, but rather the existence of at least one. A word such as “including” or “comprising” means that the element or object appearing before the word covers the element or object listed after the word and its equivalents, without excluding other components or objects. Similar words such as “connection” or “connected” are not limited to physical or mechanical connections, but may include electrical connections, whether direct or indirect. Orientation words such as “up”, “down”, “left”, “right” are only used to indicate relative position relationships based on the drawings, and when the absolute position of the object being described changes, the relative position relationship may also change accordingly.

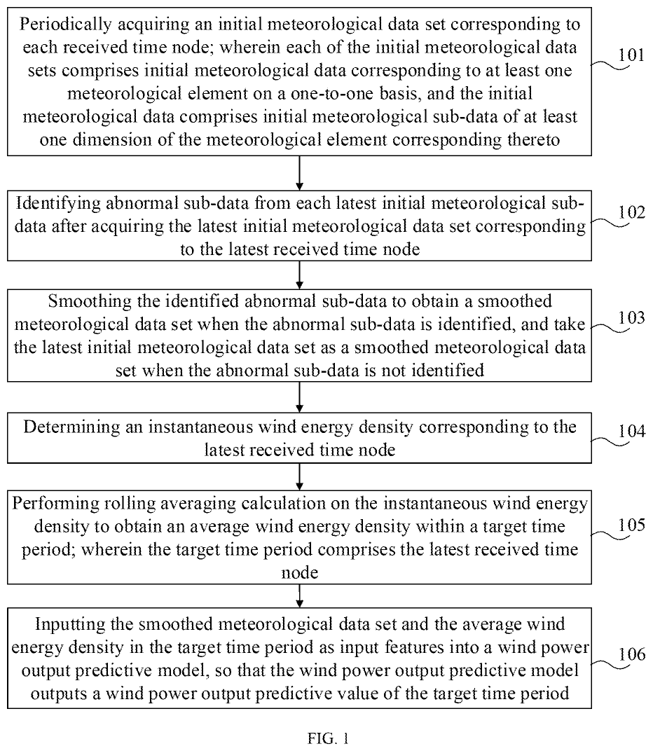

FIG. 1 shows a flow chart of steps of a prediction method of wind power output according to an embodiment of the present disclosure, the method is used to predicting the wind power output of a wind power station, referring to FIG. 1, the method includes the following steps:

Step 101: periodically acquiring an initial meteorological data set corresponding to each received time node; wherein each of the initial meteorological data sets comprises initial meteorological data corresponding to at least one meteorological element on a one-to-one basis, and the initial meteorological data comprises initial meteorological sub-data of at least one dimension of the meteorological element corresponding thereto.

In this step, an electronic device may obtain an initial meteorological data set from the wind power station at regular time intervals, and a received time node corresponding to the initial meteorological data set may be a time when the initial meteorological data set is received by the electronic device. For each initial meteorological sub-data in the initial meteorological data set, the electronic device may store according to the corresponding relationship between the received time node and the initial meteorological sub-data, see Table 1 below.

TABLE 1

| | Dimension of meteorological element | | | |
|---|---|---|---|---|
| | Temperature | Wind speed at 70 | | |
| Received | at 30 meters | meters from | Surface | |
| time node | from surface | surface | pressure | . . . |
| 2021 Sep. 10 12:00 | 20.3 | 8.2 | 1013 | . . . |
| 2021 Sep. 10 12:15 | 20.5 | nan | 1004 | . . . |
| 2021 Sep. 10 12:30 | 20.4 | 8.7 | 1020 | . . . |
| . . . | . . . | . . . | . . . | . . . |

It is to be understood that the data in Table 1 above is exemplary only and is not intended to limit the present disclosure.

In practice, the wind power station may perform data collection for at least one meteorological element, and therefore each initial meteorological data set may comprise a plurality of initial meteorological data, each initial meteorological data corresponding to a meteorological element. In some alternative embodiments, the meteorological elements may include wind speed, gas density, air pressure, and air temperature, and certainly, may also include wind direction, etc. and the disclosed embodiments are not intended to limit it.

Further, for each meteorological element, the wind power station may also perform data acquisition from at least one dimension, and different dimensions may specifically refer to different locations, different heights, different objects, etc.

Taking wind speed as an example, wind speeds at different heights from the surface can be collected, such as wind speed at 100 meters from the surface, wind speed at 70 meters from the surface, wind speed at 30 meters from the surface, etc. It is also possible to collect the wind speed at different locations, e.g., at locations between the fans, at the hub of the fan etc.

Taking the gas density as an example of a meteorological element, the density of different gas objects, such as air density, can be collected.

Taking atmospheric pressure as an example, atmospheric pressure can be collected at different locations, such as surface atmospheric pressure, sea level atmospheric pressure, etc.

Taking the air temperature as an example, the air temperature at different heights from the surface can be collected, for example, the air temperature at 30 meters from the surface, the air temperature at 2 meters from the surface, etc.

After the electronic device obtains the initial data from the wind power station, the electronic device can use the initial data as input features of the model to predict the wind power output.

Step 102: identifying abnormal sub-data from each latest initial meteorological sub-data after acquiring the latest initial meteorological data set corresponding to the latest received time node.

In practice, the acquired initial meteorological sub-data may be under abnormal situations such as data loss and excessive numerical deviation from the normal range due to abnormal situations of the data acquisition device, etc.; therefore, in this step, each time after the electronic device acquires the latest initial meteorological data set corresponding to the latest received time node, the electronic device can identify the abnormal sub-data in the latest initial meteorological sub-data.

Step 103: smoothing the identified abnormal sub-data to obtain a smoothed meteorological data set when the abnormal sub-data is identified, and taking the latest initial meteorological data set as a smoothed meteorological data set when the abnormal sub-data is not identified.

In this step, when the electronic device identifies abnormal sub-data from each of the latest initial meteorological sub-data, the identified abnormal sub-data can be smoothed, so that the interference of the abnormal sub-data on the prediction result can be avoided and the integrity of the data can be ensured. After processing all the abnormal sub-data in the latest initial meteorological data set, a smooth meteorological data set can be obtained.

When the electronic device does not identify the abnormal sub-data from each of the latest initial meteorological sub-data, it indicates that each of the latest initial meteorological sub-data itself is smoother data. Therefore, the electronic device can directly use the latest initial meteorological data set as the smoothed meteorological data set.

Step 104: determining an instantaneous wind energy density corresponding to the latest received time node.

The wind energy density is the wind energy when the airflow vertically passes through a unit area in a unit time, whose unit is watts per square meter, and the wind energy density is the most convenient and valuable parameter to describe a local wind energy potential, and is an important factor affecting wind power output. Therefore, in the embodiment of the present disclosure, based on the importance of the influence of the wind energy density on the wind power output, the wind energy density can also be used as an input feature of the model, so that the accuracy of the wind power output prediction can be improved.

The electronic device may first determine the instantaneous wind energy density corresponding to the latest received time node after each acquisition of the latest initial meteorological data set.

Step 105: performing rolling averaging calculation on the instantaneous wind energy density to obtain an average wind energy density within a target time period; wherein the target time period comprises the latest received time node.

The calculation of wind energy density needs to be based on wind speed data. However, due to the randomness of the wind speed, the wind energy potential of the wind power station cannot be accurately estimated by the instantaneous wind energy density. Therefore, in this step, the electronic device can perform rolling averaging calculation on each of the determined instantaneous wind energy densities in the target time period to obtain an average wind energy density in the target time period, and the average wind energy density can reflect the wind energy situation in the wind power station over a period of time more accurately, and thus can improve the accuracy of wind power output prediction.

Step 106: inputting the smoothed meteorological data set and the average wind energy density in the target time period as input features into a wind power output predictive model, so that the wind power output predictive model outputs a wind power output predictive value of the target time period.

In this step, the electronic device may deploy the wind power output predictive model in advance, and after obtaining the smoothed meteorological data set and the average wind energy density in the target time period, the electronic device may input these data as the input features of the model into the wind power output predictive model, so that the wind power output predictive model may output the wind power output predictive value in the target time period.

The electronic device can take the initial meteorological sub-data of each dimension of each meteorological element and the average wind energy density which has a great influence on the wind power output as the input features of the model, so that the wind power output predictive model can output the wind power output predictive value based on a large number of features, and thus the prediction of the wind power output can be realized. In addition, the prediction method of wind power output according to an embodiment of the present disclosure can achieve a higher prediction accuracy than a method of performing wind power output prediction based on a time series model using only a single feature of a historical wind power generation truth value.

According to an embodiment of the present disclosure, the electronic device may periodically acquire the initial meteorological data set corresponding to each received time node, wherein the initial meteorological data set comprises the initial meteorological sub-data of at least one dimension of at least one meteorological element; after acquiring the latest initial meteorological data set, identifying the abnormal sub-data, the identified abnormal sub-data is smoothed to obtain a smoothed meteorological data set when the abnormal sub-data is identified, while the latest initial meteorological data set is taken as the smoothed meteorological data set when the abnormal sub-data is not identified; then the average wind energy density in the target time period is determined; then, the smoothed meteorological data set and the average wind energy density in the target time period are taken as the input features of the model, and the wind power output predicted value in the target time period is obtained by the wind power output predictive model. According to an embodiment of the present disclosure, the electronic device may use the initial meteorological sub-data of each dimension of each meteorological element, and the average wind energy density which has a great influence on the wind power output, as the input features of the model, so that the wind power output predictive model may output the wind power output predictive value based on a large number of features, and in this way, the prediction of the wind power output can be realized and a high prediction accuracy can be obtained.

Alternatively, in some embodiments, step 101 may specifically include: periodically acquiring an initial meteorological data predictive set corresponding to each received time node; wherein the initial meteorological data predictive set is predicted based on a historical initial meteorological data truth value set corresponding to at least one historical received time node.

In some scenarios, the wind power station can provide the electronic device with meteorological data for a future period of time. i.e., meteorological forecast data, wherein the meteorological forecast data is a predicted value obtained by predicting according to historical meteorological data, rather than a truth value, and then the electronic device can predict the wind power generation output for a future period of time (i.e., a target time period) according to the meteorological forecast data for the future period of time.

For example, when it is 7:50, before 7:50, the electronic device has acquired the initial meteorological data predictive sets 1, 2, 3 and 4 at 7:00, 7:15, 7:30 and 7:45, respectively. i.e., the electronic device can acquire one initial meteorological data predictive set every 15 minutes. The initial meteorological data predictive sets 1, 2, 3 and 4 are meteorological forecast data corresponding to 8:00, 8:15, 8:30 and 8:45, respectively. At this time, the electronic device may predict the wind power generation output for the target time period of 8:00 to 9:00 based on the meteorological forecast data of 8:00 to 9:00.

In other embodiments, step 101 may specifically include: periodically acquiring an initial meteorological data truth value set corresponding to each received time node.

In other scenarios, the wind power station may provide the electronic device with meteorological data over a past period of time, i.e., meteorological historical data, which is a truth value of the meteorological data rather than a predicted value, and the electronic device may predict the wind power generation output over a future period of time (i.e., a target time period) according to the meteorological historical data over the past period of time.

For example, when it is 7:50, before 7:50, the electronic device has acquired the initial meteorological data truth value sets 1, 2, 3 and 4 at 7:00, 7:15, 7:30 and 7:45, respectively, i.e., the electronic device can acquire one initial meteorological data truth value set every 15 minutes. The initial meteorological data predictive sets 1, 2, 3 and 4 may be meteorological historical data corresponding to 7:00, 7:15, 7:30 and 7:45. At this time, the electronic device may predict the wind power generation output for the target period of 8:00 to 9:00 based on the meteorological history data of 7:00 to 8:00.

Alternatively, in some embodiments, step 102 may specifically include:
S11: rolling a second time window along a time axis so that the second time window comprises the latest received time node after acquiring the latest initial meteorological data set corresponding to the latest received time node;
S12: performing normal normalization processing on the initial meteorological sub-data which belongs to the same dimension of the same meteorological element and is a non-null value in the second time window to obtain a normal normalization value corresponding to each latest initial meteorological sub-data;
S13: determining the latest initial meteorological sub-data for which the normal normalized value is not within the preset value range to be abnormal sub-data.

The Z-score method can be used to calculate the mean value and standard deviation of the near-normal distribution meteorological data, filter out the data exceeding multiple standard deviations, reduce the range of the data and control the interference of non-null abnormal values on prediction accuracy. The Z-score method measures how many standard deviations are away from the original data and its mean in units of standard deviation.

In particular, the electronic device may perform the identification of the abnormal sub-data by means of rolling. First, a second time window may be rolled along the time axis of the received time node so that the second time window contains the current latest received time node, wherein the last bit time node in the rolled second time window is the current latest received time node. Then, for the latest initial meteorological sub-data which is a non-null value in each dimension, normal normalization processing can be performed, i.e., the calculation of the Z-score is performed, and the Z-score, i.e., the normal normalized value, is calculated.

For the latest initial meteorological sub-data a belonging to the dimension A of the meteorological element Y, the Z score of a can be calculated by the formula Z=(x−μ)/σ, wherein x is the latest initial meteorological sub-data a, μ is the mean value of a plurality of initial meteorological sub-data belonging to the dimension A of the meteorological element Y together with the latest initial meteorological sub-data a, and a is the standard deviation of the plurality of initial meteorological sub-data belonging to the dimension A of the meteorological element Y together with the latest initial meteorological sub-data a.

Thereafter, the latest initial meteorological sub-data for which the corresponding Z-score is not within the preset numerical range may be determined as the abnormal sub-data. For example, the preset value range may be [−3,3] and the electronic device may filter out non-null data that exceeds 3 times the standard deviation.

Further optionally, in some embodiments, after S11, step 102 may further comprise the steps of:
S14: determining a null value in each of the latest initial meteorological sub-data within the second time window as the abnormal sub-data.

The abnormal data includes null values in addition to non-null values that are relatively unreasonable values, and the electronic device can also determine the null values as the abnormal sub-data, so that the null values and unreasonable non-null values can be smoothed rather than directly deleted, so that the smoothed data can have temporal continuity, which is beneficial to further improve the accuracy of prediction.

In practice, with regard to the abnormal sub-data which is a non-null value, the electronic device may set the abnormal sub-data as a null value after being identified; in this way, before the subsequent smoothing processing is performed, all the abnormal sub-data in the latest initial meteorological data set are null data. In this way, when the subsequent smoothing processing is performed, the null value identification (for example, a nan value) may be directly concerned, and there is no need to pay attention to the specific row and column positions of the abnormal sub-data, thereby improving the efficiency of the smoothing processing to a certain extent.

Alternatively, in some embodiments, when the abnormal sub-data is identified in step 103, the step of smoothing each identified abnormal sub-data to obtain a smoothed meteorological data set may specifically comprise:
S21: rolling a third time window along a time axis for any identified abnormal sub-data, so that the third time window comprises a received time node corresponding to the abnormal sub-data and a plurality of received time nodes preceding the received time node corresponding to the abnormal sub-data;
S22: averaging on initial meteorological sub-data which belongs to the same dimension of the same meteorological element as the abnormal sub-data in the third time window to obtain a new value corresponding to the abnormal sub-data;
S23: replacing each abnormal sub-data with a corresponding new value to obtain a smoothed meteorological data set.

The electronic device can smooth the abnormal sub-data by means of rolling. Firstly, with regard to the dimension A of the meteorological element Y, a third time window can be rolled along the time axis of the received time node so that the third time window contains the first abnormal sub-data belonging to the dimension A of the meteorological element Y in the current latest initial meteorological data set, wherein the last time node in the rolled third time window is the received time node t1 corresponding to the first abnormal sub-data belonging to the dimension A of the meteorological element Y. and the rolled third time window further comprises a plurality of received time nodes in a period before t1. Then, each initial meteorological sub-data belonging to the dimension A of the meteorological element Y in the third time window can be averaged to obtain a new value corresponding to the first abnormal sub-data belonging to the dimension A of the meteorological element Y. Thereafter, the first abnormal sub-data belonging to the dimension A of the meteorological element Y may be replaced with a corresponding new value.

Similarly, by rolling the third time window again, the above-mentioned manner can be continued to be repeated to determine new values corresponding to the 2^{nd}, 3^{rd}, . . . , m^{th} abnormal sub-data belonging to the dimension A of the meteorological element Y. By analogy, the new value of each abnormal sub-data belonging to each dimension of other meteorological elements is determined in the same manner as the new value of each abnormal sub-data belonging to dimension A of meteorological element Y. The smoothing process is completed until all the abnormal sub-data of all the dimensions of all the meteorological elements are replaced with corresponding new values to obtain a smoothed meteorological data set.

For example, the electronic device may replace (or fill) the abnormal sub-data b with initial meteorological sub-data within one hour before the abnormal sub-data b and belonging to the same dimension of the same meteorological element as the abnormal sub-data b. Thus, ensuring that the data is relatively accurate while also considering the continuity of the data in time sequence.

Alternatively, in some embodiments, the smoothed meteorological data in the smoothed meteorological data set comprises at least a smoothed wind speed and a smoothed air density at the hub of the fan, and accordingly, step 104 may specifically comprise: determining the instantaneous wind energy density corresponding to the latest received time node according to the smooth wind speed and the smooth air density at the hub of the fan corresponding to the latest received time node.

If the latest wind speed at the hub of the fan is the abnormal sub-data and is smoothed, the smoothed wind speed at the hub of the fan is the latest wind speed at the hub of the fan after smoothing, and if the latest wind speed at the hub of the fan is not abnormal sub-data, the smoothed wind speed at the hub of the fan is the latest wind speed at the hub of the fan. Similarly, when the latest air density is the abnormal sub-data and is smoothed, the smoothed air density is the latest air density after smoothing, and when the latest air density is not the abnormal sub-data, the smoothed air density is the latest air density.

Further optionally, in some embodiments, step 105 may specifically include:
S31: rolling the first-time window along the time axis to align the first-time window with the target time period;
S32: averaging a plurality of instantaneous wind energy densities in the first-time window to obtain an average wind energy density in the target time period.

In general, the wind energy density w in a period of time (t1-t2) can be calculated by the following Formula (I), ρₜ is the air density corresponding to time t and Vₜ is the wind speed at the hub of the fan corresponding to time t.

W=∫ₜ₁^{t2}0.5·ρₜ·(Vₜ)³dt (1)

In the above-mentioned formula (1), the calculation standard is based on a period of time, but in practice, the air density and the wind speed at the hub of the fan at successive moments cannot be obtained, and the air density and the wind speed at the hub of the fan at discrete moments are obtained. Therefore, the embodiment of the present disclosure can determine the average wind energy density W in a period of time (a target time period) through the following formula (2).

$$W = \frac{1}{n} {\sum }_{i = 0}^{n} {w}_{i} \qquad ( 2 )$$

In the above-mentioned formula (2), n is the quantity of received time nodes included in the target time period, w₁ is the smooth instantaneous wind energy density corresponding to the received time node i, w₁=0.5·ρ₁·(Vₜ)³·ρₜ is the smooth air density corresponding to the received time node i, and V₁ is the smooth wind speed at the hub of the fan corresponding to the received time node i.

In practice, the electronic device may first determine a smoothed instantaneous wind energy density w₁ for each received time node i. The electronic device then sinus and averages each instantaneous wind energy density to obtain an average wind energy density in the target time period.

The electronic device can perform the calculation of the average wind energy density in a rolling manner. First, the first-time window may be rolled along a time axis of the received time node to align the first-time window with the target time period. Then, the plurality of instantaneous wind energy densities determined in the first-time window can be averaged by the above-mentioned formula (2) to obtain the average wind energy density in the target time period.

In addition, in practice, the rolling maximum value and the rolling minimum value can also be calculated for the instantaneous wind energy density.

Alternatively, in some embodiments, the wind power output predictive model may employ a boosting model. In this case, the input features of the wind power output predictive model may include only the smoothed meteorological data set and the average wind energy density in the target time period.

Because the boosting model can pay more attention to multi-feature mining, after practice, compared with only using the time series model, using the boosting model to predict wind power output can achieve higher prediction accuracy.

Further, alternatively, in other embodiments, the wind power output predictive model may employ a fusion model of the boosting model and the time series model. In this case, the input feature of the wind power output predictive model may comprise, in addition to the smoothed meteorological data set and the average wind energy density in the target time period, a historical wind power output truth value corresponding to each received time node in the target time period.

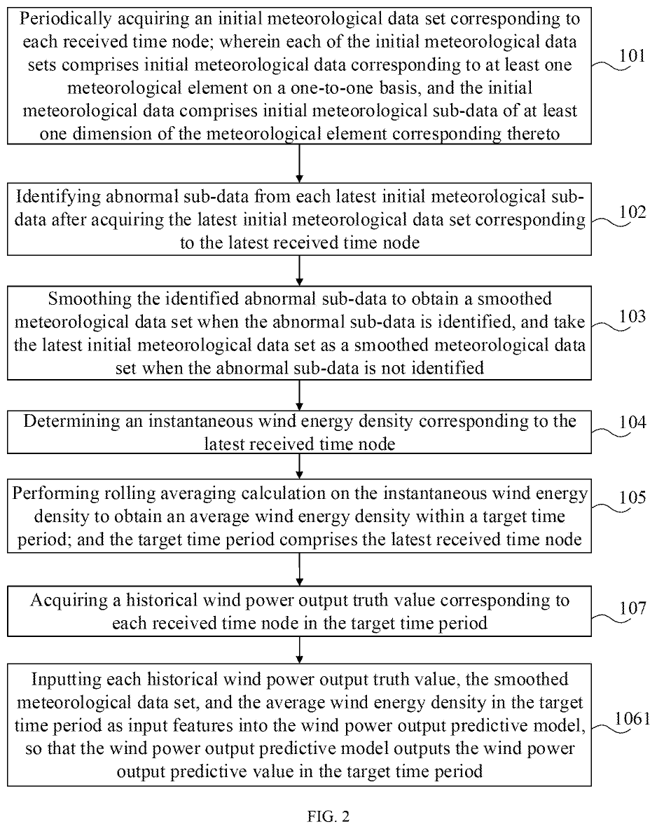

Accordingly referring to FIG. 2, before step 106, the method further includes:
step 107: acquiring a historical wind power output truth value corresponding to each received time node in the target time period.

Accordingly, referring to FIG. 2, step 106 may specifically include:
Step 1061: inputting each historical wind power output truth value, the smoothed meteorological data set and the average wind energy density in the target time period as input features into the wind power output predictive model, so that the wind power output predictive model outputs the wind power output predictive value in the target time period.

Since the boosting model can pay more attention to the multi-feature mining, and the tune series model can pay more attention to the temporal relationship of the features, after practice, compared with only using the boosting model or only using the time series model, using the fusion model of the boosting model and the time series model to predict the wind power output can achieve higher prediction accuracy.

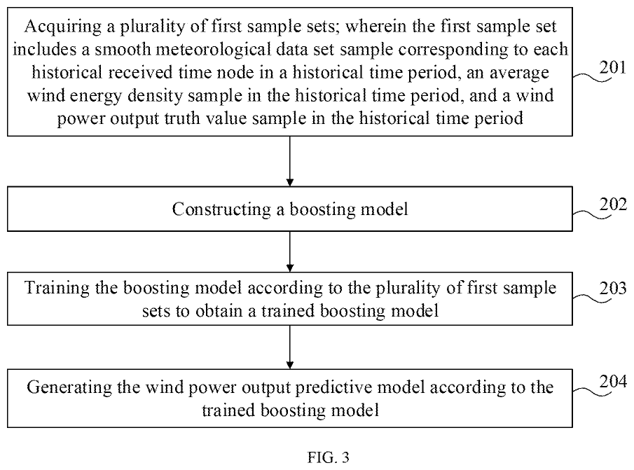

Before step 101, the method may also include a training process for the model. With reference to FIG. 3, for the case where the wind power output predictive model adopts a boosting model, the training process of the model may specifically comprise:

Step 201: acquiring a plurality of first sample sets; wherein the first sample set includes a smooth meteorological data set sample corresponding to each historical received time node in a historical time period, an average wind energy density sample in the historical time period, and a wind power output truth value sample in the historical time period.

In this step, the electronic device can acquire the plurality of first sample sets for training the boosting model, wherein the first sample set is a labeled data set, and a wind power output truth value sample in the historical time period is a label corresponding to a group of samples composed of the smooth meteorological data set sample and the average wind energy density sample in the historical time period. The historical time periods corresponding to different first sample sets are different, and the historical time periods corresponding to different first sample sets may be continuous.

Step 202: constructing a boosting model.

The boosting model is a model obtained by training using a boosting integrated learning mechanism, for example, a Gradient Boosting model; further, a Gradient Boosting Decision Tree (GBDT) model can be used in the gradient boosting model, and an Extreme Gradient Boosting (XGBoost) model or a Light Gradient Boosting Machine (lightGBM) model can be specifically used in the gradient boosting model. However, the embodiments of the present disclosure are not specifically limited thereto.

In this step, a suitable gradient boosting model, such as the lightGBM model, can be selected according to the requirements. In practice, the electronic device can acquire the boosting model from other platforms and configure same in a model pool local to the electronic device, and then the boosting model can be selected from the model pool to complete model construction. Certainly, it is also possible to directly construct the boosting model locally in the electronic device and arrange same in the model pool, and then select the boosting model from the model pool to complete the model construction.

Step 203: training the boosting model according to the plurality of first sample sets to obtain a trained boosting model.

In this step, the plurality of first sample sets can be divided into a training set and a test set, and the training set is sequentially input into the boosting model; after each input, parameters in the boosting model can be adjusted until all the training sets are input, and then the test set is input into the boosting model for model verification; and when the verification result reaches a certain accuracy, model parameter adjustment is completed to obtain a trained boosting model.

In practice, the model can be tuned by means of an automatic tuning tool, such as a hyperopt tool.

Further, alternatively, step 203 may specifically comprise: training the boosting model by cross-validation method according to the plurality of first sample sets, to obtain the trained boosting model.

In order to make the final model parameters not excessively dependent on the division mode of training set and test set, and make full use of the existing first sample set, cross-validation method can be used to train the boosting model, so that each first sample set has a chance to be used as test set individually, so that the wind power output predictive model can be optimized and the prediction accuracy can be further improved.

Step 204: generating the wind power output predictive model according to the trained boosting model.

In this step, the electronic device may locally deploy the trained boosting model to obtain a usable wind power output predictive model.

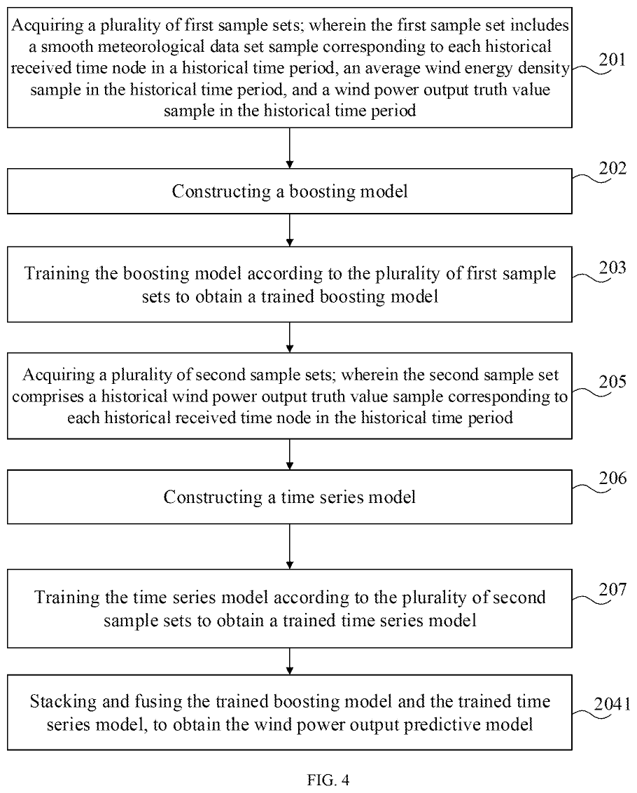

With reference to FIG. 4, for the case where the wind power output predictive model uses the fusion model of the boosting model and the time series model, before step 204, the training process of the model may further comprise:

Step 205: acquiring a plurality of second sample sets; wherein the second sample set comprises a historical wind power output truth value sample corresponding to each historical received time node in the historical time period.

In this step, the electronic device may acquire the plurality of second sample sets for training the time series model, wherein the second sample sets are unlabeled data sets. The historical time periods corresponding to different second sample sets are different, and the historical time periods corresponding to different second sample sets may be continuous.

Step 206: constructing a time series model.

In this step, an appropriate time series model such as Autoregressive Integrated Moving Average model (ARIMA model). Seasonal Autoregressive Integrated Moving Average model (SARIMA model), Long short-term memory model (LSTM model), or a variant of the above models.

Step 207: training the time series model according to the plurality of second sample sets to obtain a trained time series model.

In this step, the plurality of second sample sets can be divided into a training set and a test set, and the training set is sequentially input into a time series model; after each input, parameters in the time series model can be adjusted until all the training sets are input, and then the test set is input into the time series model for model verification; and when the verification result reaches a certain accuracy, model parameter adjustment is completed to obtain a trained time series model.

It should be noted that the training sequence of the boosting model and the time series model are not limited in the embodiment of the present disclosure, and the boosting model may be first trained by steps 201-203 and then the time series model may be trained by steps 205-207, or the time series model may be first trained by steps 205-207 and then the boosting model may be trained by steps 201-203.

Accordingly, with regard to the case where the wind power output predictive model adopts the fusion model of the boosting model and the time series model, step 204 may specifically comprise:

Step 2041: stacking and fusing the trained boosting model and the trained time series model, to obtain the wind power output predictive model.

After training the trained gradient boosting model and the trained time series model, the trained gradient boosting model and the trained time series model can be fused by stacking. The trained gradient boosting model and the trained time series model are taken as the basic models, and a meta-model is trained by the stacking integrated learning mechanism to combine these basic models.

Alternatively, the method may further comprise the steps of:
re-training the wind power output predictive model according to a plurality of new first sample sets and a plurality of new second sample sets to update the wind power output predictive model after the plurality of new first sample sets and the plurality of new second sample sets are acquired.

In practice, the situation of the wind power station is not constant, so the deployed wind power output predictive model may not reach a higher prediction accuracy after a period of time. Therefore, after the deployment of the wind power output predictive model is completed, the electronic device may further acquire or generate a lot of new data, and then these data can be taken as a new first sample set and a new second sample set, and then the old model is retrained to obtain a new model to realize the update of the model. So that the model can adapt to the change of the wind power station, thus, a high prediction accuracy can be maintained for most of the time.

Alternatively, in some embodiments, the electronic device may further be provided with a warning mechanism, in particular, the electronic device may determine whether the fans of the current wind power station are suitable for continuing operation according to data in the latest initial meteorological data set, and may perform a warning when they are not suitable for continuing operation.

In particular, the latest initial meteorological sub-data comprises at least the latest initial wind speed at the hub of the fan, and accordingly, with reference to FIG. 5, the method may also comprise the following steps of:

Step 301: monitoring the initial wind speed at the hub of the fan acquired each time starting from the latest received time node after acquiring the latest initial meteorological data set corresponding to the latest received time node when the latest initial wind speed at the hub of the fan is less than a first preset wind speed or greater than a second preset wind speed; wherein the first preset wind speed is less than the second preset wind speed.

Each time the electronic device obtains the latest initial meteorological data set, a determination can be made of the initial wind speed at the hub of the fan therein. When the initial wind speed at the hub of the fan is less than the first preset wind speed, it shows that the current wind of the wind power station is very small, and considering the loss of power transmission and other processes, the power generated by wind power is insufficient and the cost is high. When the initial wind speed at the hub of the fan is greater than the second preset wind speed, it indicates that the current wind of the wind power station is large, which may cause damage to the fan and affect the stability of the power system.

However, due to the contingency of the instantaneous wind speed, only determining by the instantaneous wind speed at the hub of the fan will cause frequent warning, and it is also necessary to manually determine whether the fan is really unsuitable to continue working, so that the warning mechanism cannot achieve a good warning effect. Therefore, according to an embodiment of the present disclosure, when the latest initial wind speed at the hub of the fan is less than the first preset wind speed or greater than the second preset wind speed, the electronic device may start monitoring the initial wind speed at the hub of the fan acquired within a period of time, and then may determine whether a warning needs to be performed in combination with the initial wind speed at the hub of the fan within a period of time.

Step 302: performing warning according to the each acquired initial wind speed at the hub of the fan monitored in a preset period of time.

The electronic device may warn when the cost of operating the fan is high, and may warn when the power system is unstable.

In the case of performing warning when the operation cost of the fan is high, step 302 may specifically comprise:
S41: outputting a warning for recommending to turn off the fan of a wind power station when each acquired initial wind speed at the hub of the fan monitored within a preset period of time is less than a first preset wind speed; alternatively,
S42: counting a quantity of wind speed data less than the first preset wind speed in each acquired initial wind speed at the hub of the fan monitored in the preset period of time; and outputting a warning for recommending to turn off the fan of the wind power station when the quantity of the wind speed data is greater than a first preset quantity.

In an alternative embodiment, after monitoring the initial wind speed at the hub of the fan for a preset period of time, a warning may be output under the condition that each initial wind speed at the hubs of the fan in the preset period of time is less than the first preset wind speed to advise relevant personnel to shut down the fan of the wind power station to reduce the running cost of the fan.

In another alternative embodiment, after monitoring the initial wind speed at the hub of the fan for a preset period of time, a warning can be output under the condition that the initial wind speed at the hub of the fan which is less than the first preset wind speed reaches a large amount of data within the preset period of time to recommend relevant personnel to turn off the fan of the wind power station to reduce the running cost of the fan.

For the case where the warning is performed when the power system is unstable, the step 302 may specifically include:
S51: outputting a warning for recommending to turn off the fan of a wind power station when each acquired initial wind speed at the hub of the fan monitored within a preset period of time is greater than a second preset wind speed; alternatively,
S52: counting a quantity of wind speed data greater than the second preset wind speed in each acquired initial wind speed at the hub of the fan monitored in the preset period of time; and outputting a warning for recommending to turn off the fan of the wind power station when the quantity of the wind speed data is greater than a second preset quantity.

In an alternative embodiment, after monitoring the initial wind speed at the hub of the fan for a preset period of time, a warning may be output when the initial wind speed at each hub of the fan during the preset period of time is greater than a second preset wind speed to advise relevant personnel to shut down the fan of the wind power station to avoid instability of the power system due to the damage of the fan.

In another alternative embodiment, after monitoring the initial wind speed at the hub of the fan for a preset period of time, a warning can be output under the condition that the initial wind speed at the hub of the fan which is greater than the second preset wind speed reaches a large amount of data within the preset period of time to recommend relevant personnel to avoid the instability of the power system caused by the damage of the fan.

Alternatively, the warning may be played with a specific audio (e.g., a special warning tone, etc.) via an audio playing apparatus such as a speaker, generate a warning light via a lighting apparatus, etc., which is not specifically limited by the embodiments of the present disclosure.

In addition, in practice, the first preset wind speed and the second preset wind speed can be set in combination with data such as a power generation cost of a specific wind power station and a historical damage condition of the fan.

The disclosed embodiments also disclose an electronic device comprising a processor, a memory and a program stored on the memory and executable on the processor, which when executed by the processor implements the steps of the prediction method of wind power output as described above.

The disclosed embodiments also disclose a non-transitory computer-readable storage medium that, when executed by a processor of an electronic device, enables the electronic device to perform the prediction method of wind power output as described above.

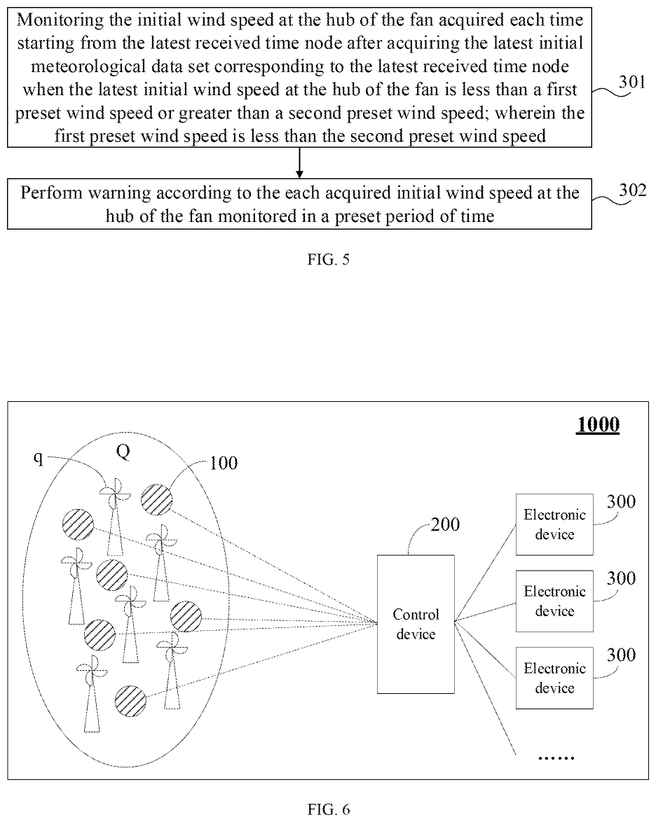

With reference to FIG. 6, the embodiment of the present disclosure also discloses a wind power control system 1000 comprising a plurality of data acquisition devices 100, and a control device 200, and an electronic device 300 as described above, wherein the data acquisition devices 100 are arranged in a wind power station Q, and the wind power station Q comprises a plurality of fans q, and the data acquisition devices 100 are communicatively connected to the control device 200, and the control device 200 is communicatively connected to the electronic device 300;
the data acquisition device 100 is configured to acquire original meteorological sub-data in the wind power station Q and to transmit the original meteorological sub-data to the control device 200;
the control device 200 is configured to generate an initial meteorological data set according to each of the original meteorological sub-data, and transmit the initial meteorological data set to the electronic device 300 according to a preset time interval, so that the electronic device 300 performs wind power output prediction; each of the initial meteorological data sets corresponds to a received time node received by the electronic device 300.

The control device can be a master control device corresponding to the data acquisition device. The control device may perform preliminary processing on each original meteorological sub-data to obtain initial meteorological sub-data, and then obtain an initial meteorological data set. The original meteorological sub-data of each dimension of each meteorological data can be acquired by at least one data acquisition device, for example, the dimension of the meteorological element wind speed at a distance of 30 meters from the surface can be acquired by a plurality of wind speed acquisition devices at a distance of 30 meters from the surface to obtain a plurality of original wind speeds (i.e., original meteorological sub-data) at a distance of 30 meters from the surface, and then the control device can calculate the mean value of the plurality of original wind speeds at a distance of 30 meters from the surface to obtain the wind speed at a distance of 30 meters from the surface to be sent to the electronic device (i e initial meteorological sub-data).

Certainly, in practice, preliminary processing includes, but is not limited to, averaging.

Further, in particular applications, the control device may provide an initial meteorological data set for more than one electronic device.

The term “one embodiment”, “embodiment” or “one or more embodiments” herein means that the specific features, structures or characteristics described in conjunction with embodiments are included in at least one embodiment of the present disclosure. Further, note that the phrase “in one embodiment” herein does not necessarily refer to the same embodiment.

A number of specific details are explained in the specification provided here. However, it is understood that embodiments of the present disclosure may be practiced without these specific details. In some instances, well-known methods, structures and techniques are not shown in detail so as not to obscure the understanding of this specification.

In the claims, any reference symbols located between the parentheses should not be constructed as a limitation on the claims. The word “comprise” does not exclude the existence of components or steps that are not listed in the claims. The word “a/an” or “one” before the component does not exclude the existence of more than one such component. The present disclosure may be implemented by means of hardware comprising a number of different elements and by means of a properly programmed computer. In the unit claims of the enumerated devices, several of these devices may be embodied by the same hardware item. The use of the words first, second, and third does not indicate any order. These words can be interpreted as names.

Finally, it should be noted that the above embodiments are only used to illustrate the technical solution of the present disclosure, and are not limited thereto. Although the present disclosure is described in detail with reference to the foregoing embodiments, those of ordinary skill in the art should understand they may still modify the technical solutions described in each of the foregoing embodiments, or equivalently replace some of the technical features. And these modifications or replacements do not depart the essence of the corresponding technical solutions from the spirit and scope of the technical solutions of each embodiment of the present disclosure.

1. A prediction method of wind power output, comprising:
periodically acquiring an initial meteorological data set corresponding to each received time node; wherein each of the initial meteorological data sets comprises initial meteorological data corresponding to at least one meteorological element on a one-to-one basis, and the initial meteorological data comprises initial meteorological sub-data of at least one dimension of the meteorological element corresponding thereto;
identifying abnormal sub-data from each latest initial meteorological sub-data after acquiring the latest initial meteorological data set corresponding to the latest received time node;
smoothing the identified abnormal sub-data to obtain a smoothed meteorological data set when the abnormal sub-data is identified, and taking the latest initial meteorological data set as a smoothed meteorological data set when the abnormal sub-data is not identified;
determining an instantaneous wind energy density corresponding to the latest received time node;
performing rolling averaging calculation on the instantaneous wind energy density to obtain an average wind energy density within a target time period; wherein the target time period comprises the latest received time node; and
inputting the smoothed meteorological data set and the average wind energy density in the target time period as input features into a wind power output predictive model, so that the wind power output predictive model outputs a wind power output predictive value of the target time period.

2. The method according to claim 1, wherein the performing rolling averaging calculation on the instantaneous wind energy density to obtain an average wind energy density within a target time period comprises:
rolling the first-time window along the time axis to align the first-time window with the target time period; and
averaging a plurality of instantaneous wind energy densities in a first-time window to obtain an average wind energy density in the target time period.

3. The method according to claim 1, wherein the smoothed meteorological sub-data in the smoothed meteorological data set comprises at least a smoothed wind speed and a smoothed air density at a hub of the fan, and the determining the instantaneous wind energy density corresponding to the latest received time node comprises:
determining the instantaneous wind energy density corresponding to the latest received time node according to the smooth wind speed and the smooth air density at the hub of the fan corresponding to the latest received time node.

4. The method according to claim 1, wherein the identifying abnormal sub-data from each latest initial meteorological sub-data after acquiring the latest initial meteorological data set corresponding to the latest received time node comprises:
rolling a second time window along a time axis so that the second time window comprises the latest received time node after acquiring the latest initial meteorological data set corresponding to the latest received time node;
performing normal normalization processing on the initial meteorological sub-data which belongs to the same dimension of the same meteorological element and is a non-null value in the second time window to obtain a normal normalization value corresponding to each latest initial meteorological sub-data; and
determining the latest initial meteorological sub-data for which the normal normalized value is not within the preset value range to be the abnormal sub-data.

5. The method according to claim 4, wherein after the rolling a second time window along a time axis so that the second time window comprises the latest received time node after acquiring the latest initial meteorological data set corresponding to the latest received time node, the method further comprises:
determining a mill value in each of the latest initial meteorological sub-data within the second time window as the abnormal sub-data.

6. The method according to claim 1, wherein the smoothing each of the identified abnormal sub-data to obtain a smoothed meteorological data set when the abnormal sub-data is identified comprises:
rolling a third time window along a time axis for any one of the identified abnormal sub-data, so that the third time window comprises the received time node corresponding to the abnormal sub-data and a plurality of received time nodes preceding the received time node corresponding to the abnormal sub-data;
averaging on initial meteorological sub-data which belongs to the same dimension of the same meteorological element as the abnormal sub-data in the third time window to obtain a new value corresponding to the abnormal sub-data; and
replacing each abnormal sub-data with a corresponding new value to obtain a smoothed meteorological data set.

7. The method according to claim 1, wherein the periodically acquiring an initial meteorological data set corresponding to each received time node comprises:
periodically acquiring an initial meteorological data predictive set corresponding to each received time node; wherein the initial meteorological data predictive set is predicted based on a historical initial meteorological data truth value set corresponding to at least one historical received time node.

8. The method according to claim 1, wherein the periodically acquiring an initial meteorological data set corresponding to each received tune node comprises:
periodically acquiring an initial meteorological data truth value set corresponding to each received time node.

9. The method according to claim 1, wherein before the periodically acquiring an initial meteorological data set corresponding to each received time node, the method further comprises:
acquiring a plurality of first sample sets; wherein the first sample set includes a smooth meteorological data set sample corresponding to each historical received time node in a historical time period, an average wind energy density sample in the historical time period, and a wind power output truth value sample in the historical time period;
constructing a boosting model;
training the boosting model according to the plurality of first sample sets to obtain a trained boosting model; and
generating the wind power output predictive model according to the trained boosting model.

10. The method according to claim 9, wherein the training the boosting model according to the plurality of first sample sets to obtain a trained boosting model comprises:
training the boosting model by a cross-validation method according to the plurality of first sample sets to obtain a trained boosting model.

11. The method according to claim 9, wherein before inputting the smoothed meteorological data set and the average wind energy density within the target time period as input features into a wind power output predictive model, so that the wind power output predictive model outputs a wind power output predictive value of the target time period, the method further comprises:
acquiring a historical wind power output truth value corresponding to each received time node in the target time period;
wherein the inputting the smoothed meteorological data set and the average wind energy density within the target time period as input features into a wind power output predictive model, so that the wind power output predictive model outputs a wind power output predictive value of the target time period, comprises:
inputting the historical wind power output truth value, the smoothed meteorological data set, and the average wind energy density within the target time period as input features into a wind power output predictive model, so that the wind power output predictive model outputs a wind power output predictive value of the target time period.

12. The method according to claim 11, wherein before generating the wind power output predictive model according to the trained boosting model, the method further comprises:
acquiring a plurality of second sample sets; wherein the second sample set comprises a historical wind power output truth value sample corresponding to each historical received time node in the historical time period;
constructing a time series model;
training the time series model according to the plurality of second sample sets to obtain a trained time series model; and
the generating the wind power output predictive model according to the trained boosting model comprises:
stacking and fusing the trained boosting model and the trained time series model, to obtain the wind power output predictive model.

13. The method according to claim 12, further comprising:
re-training the wind power output predictive model according to a plurality of new first sample sets and a plurality of new second sample sets to update the wind power output predictive model after the plurality of new first sample sets and the plurality of new second sample sets are acquired.

14. The method according to claim 1, wherein the meteorological elements comprise wind speed, gas density, gas pressure and air temperature.

15. The method according to claim 1, wherein the latest initial meteorological sub-data comprises at least the latest initial wind speed at the hub of the fan, the method further comprises:
monitoring the initial wind speed at the hub of the fan acquired each time starting from the latest received time node after acquiring the latest initial meteorological data set corresponding to the latest received time node when the latest initial wind speed at the hub of the fan is less than a first preset wind speed or greater than a second preset wind speed; wherein the first preset wind speed is less than the second preset wind speed; and
performing warning according to the each acquired initial wind speed at the hub of the fan monitored in a preset period of time.

16. The method according to claim 15, wherein the performing warning according to the each acquired initial wind speed at the hub of the fan monitored in a preset period of time comprises:
outputting a warning for recommending to turn off the fan of a wind power station when each acquired initial wind speed at the hub of the fan monitored within the preset period of time is less than the first preset wind speed; or
counting a quantity of wind speed data less than the first preset wind speed in each acquired initial wind speed at the hub of the fan monitored in the preset period of time; and outputting a warning for recommending to turn off the fan of the wind power station when the quantity of the wind speed data is greater than a first preset quantity.

17. The method according to claim 15, wherein the performing warning according to the each acquired initial wind speed at the hub of the fan monitored in a preset period of time comprises:
outputting a warning for recommending to turn off the fan of the wind power station when each acquired initial wind speed at the hub of the fan monitored within a preset period of time is greater than a second preset wind speed; or
counting a quantity of wind speed data greater than the second preset wind speed in each acquired initial wind speed at the hub of the fan monitored in the preset period of time; and outputting a warning for recommending to turn off the fan of the wind power station when the quantity of the wind speed data is greater than a second preset quantity.

18. An electronic device, comprising a processor, a memory and a program stored on the memory and executable on the processor, which when executed by the processor, implementing the steps of the prediction method of wind power output according to claim 1.

19. A non-transitory computer-readable storage medium, wherein instructions in the storage medium, when executed by a processor of an electronic device, enable the electronic device to perform the prediction method of wind power output according to claim 1.

20. A wind power control system, comprising a plurality of data acquisition devices, a control device, and the electronic device according to claim 18, wherein the data acquisition devices are provided in a wind power station, the data acquisition devices are communicatively connected to the control device, and the control device is communicatively connected to the electronic device;
wherein the data acquisition device is configured to acquire original meteorological sub-data in the wind power station and to transmit the original meteorological sub-data to the control device; and
the control device is configured to generate an initial meteorological data set according to each of the original meteorological sub-data, and transmit the initial meteorological data set to the electronic device according to a preset time interval, so that the electronic device performs wind power output prediction; and each of the initial meteorological data sets corresponds to a received time node received by the electronic device.
